(19) United States
(12) Patent Application Publication
(10) Pub. No.: US 2011/0135954 A1
(43) Pub. Date: Jun. 9, 2011

(54) FRICTION STIR WELDING METHOD AND FRICTION STIR WELDED HOUSING

(75) Inventors: KOICHI NAKAGAWA, Tokyo (JP); QING LIU, Shenzhen City (CN); ISAO SHIOZAWA, Tokyo (JP); TAKEO NAKAGAWA, Tokyo (JP)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW); FINE TECH CORPORATION, Tokyo (JP)

(21) Appl. No.: 12/750,890

(22) Filed: Mar. 31, 2010

(30) Foreign Application Priority Data
Dec. 3, 2009 (CN) 200910310849.8

(51) Int. Cl. B32B 15/01; B23K 20/12

(52) U.S. Cl. 428/615; 228/112.1

(57) ABSTRACT

A friction stir welding method utilizes a joining tool comprising a friction surface, a first workpiece comprising a first treating layer and a first joining surface angled to the first treating layer, and a second workpiece comprising a second treating layer and a second joining surface joining the first joining surface of the first workpiece. The first workpiece is angled or perpendicular to the second workpiece such that the first treating layer is angled or perpendicular to the second treating layer. The first treating layer abuts the second treating layer. The friction surface of the joining tool resists the first treating layer of the first workpiece and the joining tool is rotated and moved to agitate the first workpiece until at least part of the first workpiece and the second workpiece are plasticized and joined together.

### CROSS-REFERENCE TO RELATED APPLICATIONS

This application is related to three co-pending U.S. patent applications, which are: application Ser. No. 12/729,407, filed on Mar. 23, 2010, and entitled “FRICTION STIR WELDING METHOD AND FRICTION STIR WELDED HOUSING”, application Ser. No. 12/728,387, filed on Mar. 22, 2010, and entitled “FRICTION STIR WELDING METHOD”, application Ser. No. [to be determined], with Attorney Docket No. US29454, and entitled “FRICTION STIR WELDING METHOD”. In Ser. No. 12/729,407, Ser. No. 12/728,387, Attorney Docket No. US29454, the inventors are Koichi Nakagawa, Qing Liu, Isao Shiozawa, and Takeo Nakagawa, the assignee is HONG FU JIN PRECISION INDUSTRY (ShenZhen) CO., LTD, Hon HAI PRECISION INDUSTRY CO. LTD and FINE TECH Corporation.

### BACKGROUND

1. Technical Field

The present disclosure generally relates to friction stir welding, and particularly, to a friction stir welding method using a joining tool with no mixing pin and a friction stir welded housing.

2. Description of Related Art

Friction stir welding is widely used to join aluminum alloy because it is simple to execute.

The surface of the stir-welded housing can be uneven because the material of the stir-welded portion of the housing flows during friction stir welding. After treatment, different aspects between the stir-welded and non-stir-welded portions of the housing may be visible, creating an unfavorable appearance. Despite annealing, the difference of the joined portion can persist.

Achievement of a favorable appearance in housings obtained by friction stir welding remains a challenge.

Therefore, an improved friction stir welding method is desired to overcome the described limitations.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic view of a joining tool used in a first embodiment of a friction stir welding method of the disclosure.

FIG. 2 is a bottom view of the joining tool of FIG. 1.

FIG. 3 is a bottom view of a joining tool of a second embodiment of a friction stir welding method of the disclosure.

FIG. 4 is a schematic view of a first workpiece and a second workpiece to be joined in a friction stir welding method as disclosed.

FIG. 5 is a schematic view showing a joining tool friction stirring the first workpiece and the second workpiece of FIG. 4.

FIG. 6 is a schematic view of one embodiment of a friction stir welded housing with an assisting member.

FIG. 7 is a flowchart of a friction stir welding method as disclosed.

FIG. 8 is a schematic view of a third workpiece and a fourth workpiece to be joined in a friction stir welding method as disclosed.

FIG. 9 is a schematic view of a joining tool friction stirring the third workpiece and the fourth workpiece of FIG. 8.

### DETAILED DESCRIPTION

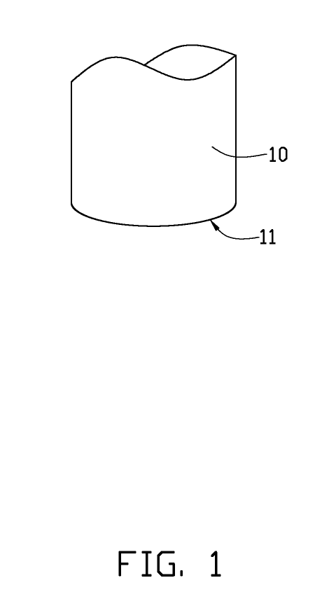

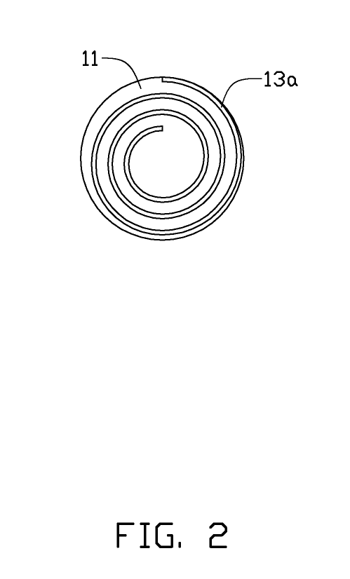

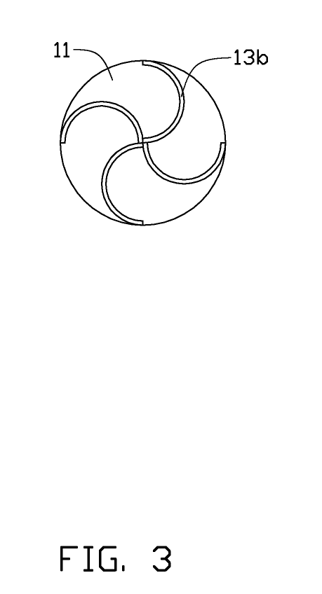

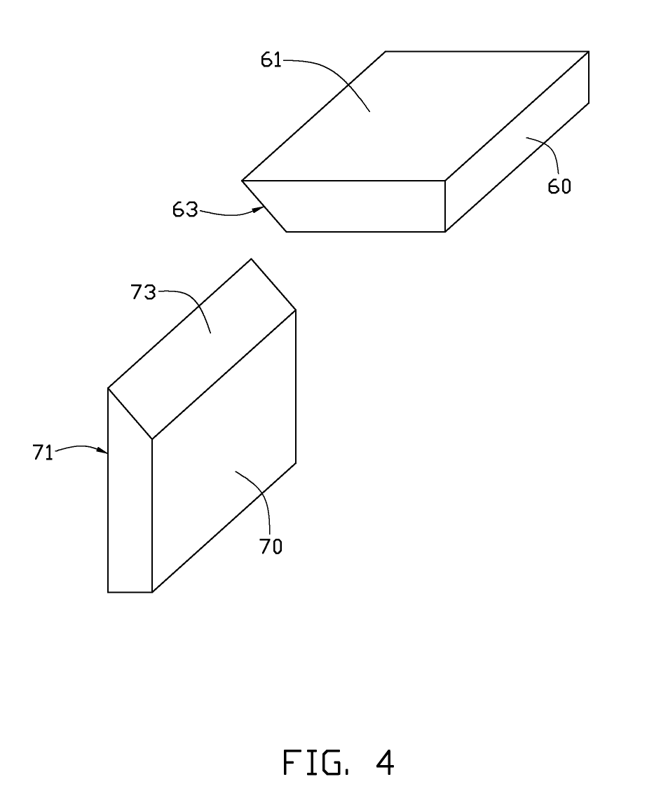

Referring to FIGS. 1 and 4, a joining tool 10 joins a first workpiece 60 and a second workpiece 70 in a friction stir welding method. The joining tool 10 is substantially cylindrical and includes a friction surface 11. The friction surface 11 is substantially flat. The joining tool 10 defines a slot 13a, 13b in the friction surface 11. In a first embodiment of the joining tool, the slot 13a may be spiral as shown in FIG. 2, and in a second embodiment of the joining tool, the slot 13b may include a plurality of curved slots 13b originating at a rotation axis of the joining tool 10, as shown in FIG. 3.

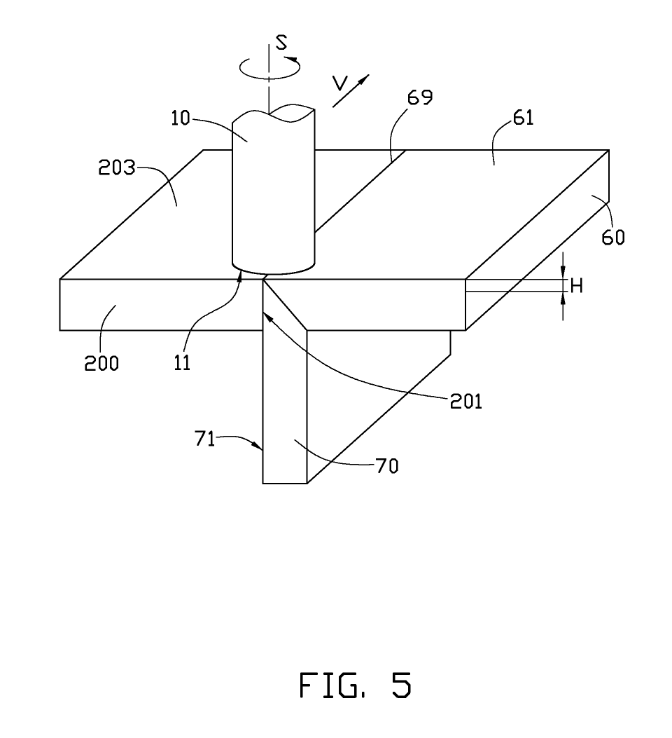

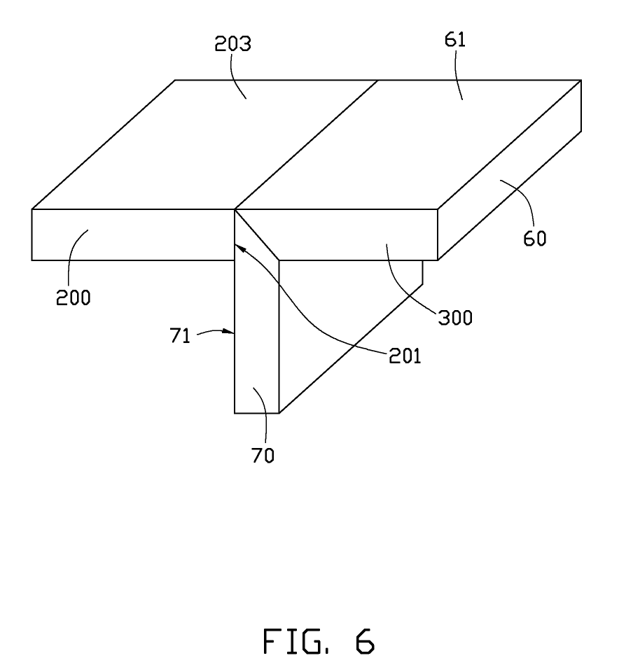

Referring to FIGS. 1, 4 through 6, the first workpiece 60 includes a first treating layer 61 and a first joining surface 63 angled therewith. The second workpiece 70 includes a second treating layer 71 and a second joining surface 73 angled from the second treating layer 71. The first workpiece 60 and the second workpiece 70 are fixed abutting each other, wherein the first joining surface 63 contacts the second joining surface 73. An angle is defined by the first treating layer 61 of the first workpiece 60 and the second treating layer 71 of the second workpiece 70, between 0° and about 180°. In the illustrated embodiment, the angle is about 90°. The first joining surface 63 and the second joining surface 73 define a joint line 69 therebetween, at an edge of the corner defined by the first workpiece 60 and the second workpiece 70.

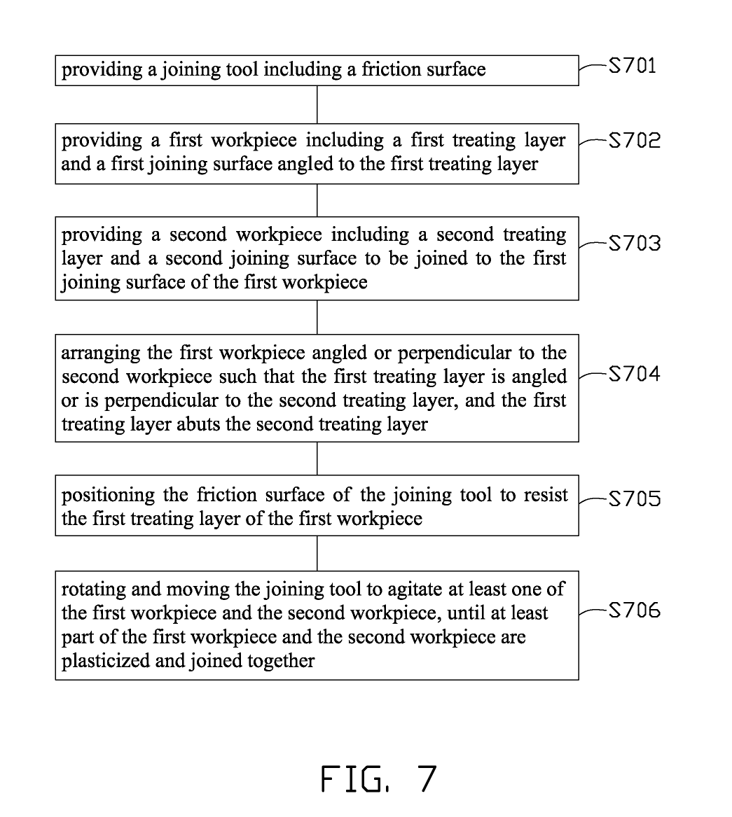

Referring to FIGS. 1, 4 through 7, the method of the friction stir welding method is as follows. In step S701, a joining tool 10 comprising a friction surface 11 is provided. In step S702, a first workpiece 60 is provided, the first workpiece 60 comprising a first treating layer 61 and a first joining surface 63 angled on the first treating layer 61. In step S703, a second workpiece 70 is provided, the second workpiece 70 comprising a second treating layer 71 and a second joining surface 73 joining to the first joining surface 63 of the first workpiece 60. In step S704, the first workpiece 60 is arranged angled or perpendicular to the second workpiece 70 such that the first treating layer 61 is angled or perpendicular to the second treating layer 71, and the first treating layer 61 abuts the second treating layer 71. In step S705, the friction surface 11 of the joining tool 10 resists the first treating layer 61 of the first workpiece 60. In step S706, the joining tool 10 is rotated and moved to agitate the first workpiece 60, until at least part of the first workpiece 60 and the second workpiece 70 are plasticized and joined together.

During joining of the first workpiece 60 and the second workpiece 70, an assisting member 200 is provided. The assisting member 200 includes a first end surface 201 and a second end surface 203 substantially perpendicular to the first end surface 201. The first end surface 201 of the assisting member 200 resists the second treating surface 71 of the second workpiece 70 and the second end surface 203 of the assisting member 200 is aligned on the same plane as the first treating surface 61 of the first workpiece 60.

The friction surface 11 of the joining tool 10 resists the first treating layer 61 of the first workpiece 60 and the second end surface 203 of the assisting member 200. The joining tool 10 rotates along the axis thereof relative to the first workpiece 60 and the assisting member 200 and moves along the joint line 69. Thus, the joining tool 10 produces a local region of highly plasticized material such that the first workpiece 60 and the second workpiece 70 diffuse with each other. As such, the first workpiece 60 and the second workpiece 70 are joined to form a friction stir welded housing 300. The assisting member 200 is detached from the first workpiece 60 and the second workpiece 70.

In the joining method as disclosed, a rotation direction of the joining tool 10 is the same as an extending direction from a center to a periphery of the joining tool 10. The joining tool 10 rotates at a high speed and moves at a low speed, and an end of the joining tool 10 extends slightly into the first treating layer of the first workpiece 60 and the second treating layer of the second workpiece 70. A rotation speed S and operating velocity V of the joining tool 10, a stir-welded depth H of the first workpiece 60 and the second workpiece 70 are determined by various factors, such as the material and thickness of the first workpiece 60 and the second workpiece 70, and the size and material of the joining tool 10, so long as the first workpiece 60 and the second workpiece 70 can be joined. In the illustrated embodiment, the first workpiece 60 and the second workpiece 70 are aluminum alloy plates. the rotation speed S is about 7000 rpm, the operating velocity V is about 500 mm/min, and the stir-welded depth H is about 0.15 mm.

Because the first treating layer 61 of the first workpiece 60 is angled to the second treating layer 71 of the second workpiece 70, the joint line 69 is superposed to an edge line. As such, the joint line 69 is hidden. The assisting member 200 increases the friction and stirred area, as does the friction heat. The increased heat is transmitted to the first workpiece 60 and the second workpiece 70 to enhance connection therebetween. The removed layers of the first workpiece 60 and the second workpiece 70 are very thin. In addition, the assisting member 200 resists the second workpiece 70, which helps to position and balance the first workpiece 60 and the second workpiece 70. The assisting member 200 may also be omitted.

The friction stir welding method further includes a process of machining the friction stir welded housing 300. Fox example, after the first workpiece 60 is joined to the second workpiece 70, surface layers adjacent to the first treating layers 61 and the second treating layer 71 may be removed. That is, material with a changed metal structure is removed and material with unchanged metal structure is exposed. Therefore, the friction stir welded housing 300 formed by the described friction stir welding method can provide a favorable appearance, even after subsequent treatment such as anodic process.

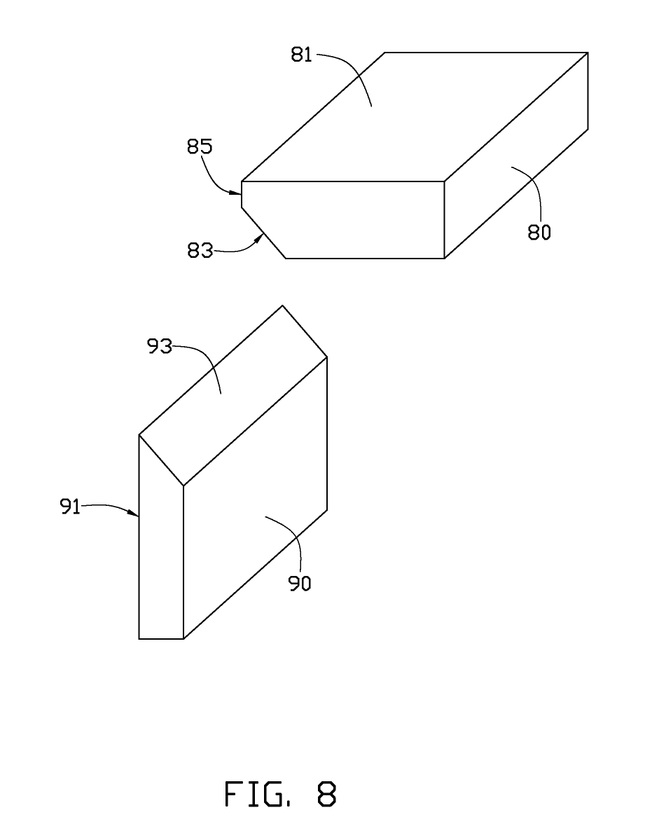

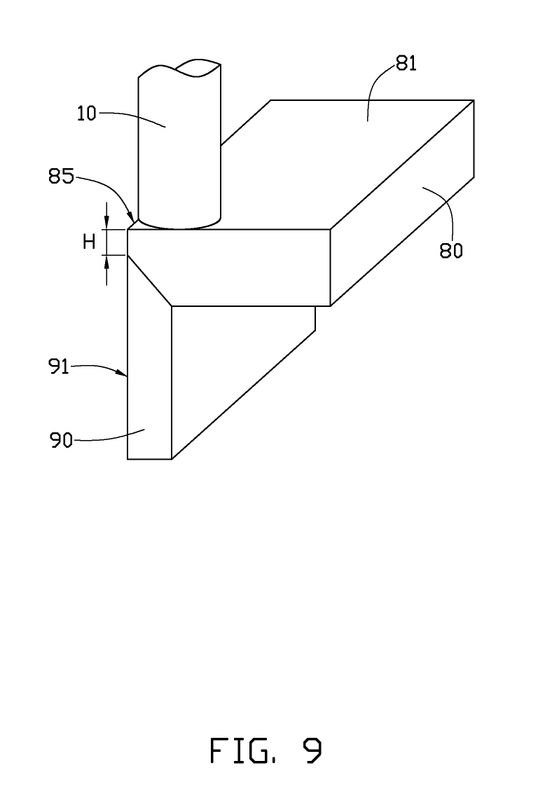

Referring to FIGS. 1, 8 and 9, a third workpiece 80 includes a third treating layer 81, a third joining surface 83 angled to the third treating layer 81, and a side surface 85 connecting the third treating layer 81 and the third joining surface 83. A fourth workpiece 90 includes a fourth treating layer 91 and a fourth joining surface 93 angled to the fourth treating layer 91.

The third workpiece 80 and the fourth workpiece 90 are fixed after abutting each other, and the third joining surface 83 contacts the fourth joining surface 93. The side surface 85 of the third workpiece 80 is aligned on the same plane as the fourth treating layer 91 of the fourth workpiece 90. An angle is defined by the side surface 85 of the third workpiece 80 and the third treating layer 81 of the third workpiece 80, between 0° and 180°. In the illustrated embodiment, the angle is about 90°. The third joining surface 83 of the third workpiece 80 and the fourth joining surface 93 of the fourth workpiece 90 define a joint line 89 between the side surface 85 of the third workpiece 80 and the fourth treating layer 91 of the fourth workpiece 90.

During a joining process, the friction surface 11 of the joining tool 10 resists the third treating surface 81 of the third workpiece 80. The joining tool 10 rotates along the axis thereof relative to the third workpiece 80 and moves along the joint line 89. Thus, the joining tool 10 produces a local region of highly plasticized material in the third treating layer such that the third workpiece 80 and the fourth workpiece 90 diffuse between each other.

In the joining method as disclosed, a rotation direction of the joining tool 10 is the same as an extending direction from a center to a periphery of the joining tool 10. The joining tool 10 rotates at a high speed and moves at a low speed, and an end of the joining tool 10 extends slightly into the third treating layer of the third workpiece 80. A rotation speed and operating velocity of the joining tool 10, and a stir-welded depth H of the third workpiece 80 are determined by various factors, such as the material and thickness of the third workpiece 80, and the size and material of the joining tool 10, so long as the third workpiece 80 and the fourth workpiece 90 can be joined, with only parts of the third workpiece 80 plasticized flow and create enough heat to the third joining surface 83 of the third workpiece 80 and the fourth joining surface 93 of the fourth workpiece 90. In addition, after the third workpiece 80 is joined to the fourth workpiece 90, surface layers of the agitated third workpiece 80 may be removed.

The workpieces 60, 70, 80, 90 may be any material with low melting point, such as aluminum, aluminum alloy, copper alloy, or plastic material, and be of any shape. Material of the joining tool 10 is a critical determining factor depending on the material of the workpieces 60, 70, 80, 90. Increased melting point of the joining tool 10 allows a higher melting point of the material of the workpieces 60, 70, 80, 90. The melting point of the joining tool 10 must exceed that of the first workpieces 60, 70, 80, 90. Joining portions of the workpieces 60, 70, 80, 90 may be points, line, or surface.

The disclosed friction stir welding method forms a housing 300 with lower joint strength requirements. If a housing 300 with strong joint strength is desired, the workpieces 60, 70, 80, 90 may define a slot (not shown) at the joining portion in which a joining member with a melting point lower than the workpieces is received. The joining member is disposed away from the rubbed and stirred portion of the workpieces, thus the joining member may transmit heat to material away from the rubbed and stirred portion. Therefore, joining strength is enhanced.

In the disclosed friction stir welding methods, only the joint of the workpieces need to be machined, so that the joining tool 10 is small, with a correspondingly low driving force thereof required. Equipment applying the joining tool 10 to friction stir welding is simple and low cost.

The joining tool 10 may be applied in ordinary machining centers (not shown), whereby workpieces may be machined and joined at the same machining center. As such, the workpieces need only be clamped once, thus improving machining efficiency and precision. In addition, no special machine is needed. Furthermore, the friction stir welding method can be used to join workpieces with complex joining surfaces.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A friction stir welding method, comprising:
providing a joining tool comprising a friction surface;
providing a first workpiece comprising a first treating layer and a first joining surface angled to the first treating layer;
providing a second workpiece comprising a second treating layer and a second joining surface to be joined to the first joining surface of the first workpiece;
arranging the first workpiece angled to the second workpiece such that the first treating layer is angled to the second treating layer, and the first treating layer abuts the second treating layer;
positioning the friction surface of the joining tool to resist the first treating layer of the first workpiece; and
rotating and moving the joining tool to agitate at least one of the first workpiece and the second workpiece, until at least part of the first workpiece and the second workpiece are plasticized and joined together.

2. The friction stir welding method of claim 1, further comprising providing an assisting member comprising a first end surface and a second end surface abutting the first end surface, wherein the first end surface of the assisting member resists the second treating surface of the second workpiece, and the second end surface of the assisting member is aligned on the same plane as the first treating surface of the first workpiece.

3. The friction stir welding method of claim 2, further comprising detaching the assisting member from the first workpiece and the second workpiece.

4. The friction stir welding method of claim 1, wherein the first workpiece is substantially perpendicular to the second workpiece, and the first end surface of the assisting member is substantially perpendicular to the second end surface.

5. The friction stir welding method of claim 4, wherein the joint line is superposed to an edge line of the joined first and second workpieces.

6. The friction stir welding method of claim 1, further comprising removing a surface layer of the agitated first workpiece or second workpiece, after joining the first workpiece and the second workpiece.

7. The friction stir welding method of claim 1, wherein the first workpiece further comprises a side surface aligned on the same plane as the second treating layer of the second workpiece, and only the first workpiece is agitated.

8. The friction stir welding method of claim 7, further comprising removing a surface layer of the agitated first workpiece, after joining the first workpiece and the second workpiece.

9. A friction stir welded housing, comprising:
a first workpiece; and
a second workpiece joined with the first workpiece;
wherein a joint line is defined between the first and second workpiece; material structure of the joint of the first workpiece and the second workpiece is substantially the same as the first workpiece and the second workpiece before joining; the joint line is superposed to an edge of the housing.

10. The friction stir welded housing of claim 9, further comprising an anodic layer.
